(19) United States
(12) Patent Application Publication
(10) Pub. No.: US 2024/0016326 A1
(43) Pub. Date: Jan. 18, 2024

(54) HOLLOW PAPER HANGING ORNAMENT

(71) Applicant: Tree Island International Inc., Fenyuan Township (TW)

(72) Inventors: JIA-HUEY YANG, Fenyuan Township (TW); YU-EN HUNG, Fenyuan Township (TW); YU-LUN HUNG, Fenyuan Township (TW); YUAN-TUNG HUNG, Fenyuan Township (TW)

(73) Assignee: Tree Island International Inc., Fenyuan Township (TW)

(21) Appl. No.: 18/359,739

(22) Filed: Jul. 26, 2023

Related U.S. Application Data
(62) Division of application No. 17/832,954, filed on Jun. 6, 2022.

(30) Foreign Application Priority Data
May 11, 2022 (TW) 111117678

(51) Int. Cl. A47G 33/08; B44C 5/00

(52) U.S. Cl. CPC A47G 33/08; B44C 5/00

(57) ABSTRACT

A hollow paper hanging ornament includes a hollow body made of paper, the hollow body having a shell and an inner space within the shell, the shell being provided with a through hole, which communicates with the inner and outer spaces of the shell, and a plug set in the through hole of the hollow body to provide the function of decoration or hanging.

### BACKGROUND OF THE INVENTION

### Field of the Invention

The present invention is related to ornaments used for decoration, in particular to a hollow paper hanging ornament.

### 2. Description of the Related Art

In many festivals, people will hang many beautiful and colorful ornaments 1 to decorate the celebration. For example: at Christmas, people will hang many Christmas balls on the Christmas tree to decorate the Christmas tree. In the early days, most of this type of products were blown from glass, so a protruding neck 2 required for blowing would be left at the opening of the finished product, therefore, one side of the sphere will protrude a section, and the appearance will look a bit longer, as shown in FIG. 1. Later, due to the popularity of plastic products, many of these products are now made of plastic, but still retain the shape of the original glass products and also have a protruding neck. Although plastic products are cheap and easy to use, they require a lot of mold costs to manufacture, and plastic products are not environmentally friendly. A large number of discarded plastic products will cause environmental pollution and damage. Therefore, it is necessary to propose a new environmentally friendly product to replace.

Generally speaking, paper is regarded as a more environmentally friendly material, but traditional paper ornaments are mostly flat printed ornaments, and rarely have a three-dimensional structure. The present invention can use paper to form a hollow ornamental structure by means of two-mold joint molding.

### SUMMARY OF THE INVENTION

The main object of the present invention is to provide a hollow paper hanging ornament made of environmentally friendly materials. In the hollow paper hanging ornament of the present invention, the hollow body can be made of pulp, and has a through hole, so that the liquid pulp in the pulp forming process can flow in and out, and the removal of the traditional glass or plastic product neck protrusion design can improve the yield of pulp products. It increases the unique beauty of paper products, and is also easy to combine with a plug.

To achieve this and other objects of the present invention, the hollow paper hanging ornament comprises a hollow body and a plug. The hollow body is made of paper, comprising a shell and an inner space within the shell. The shell is provided with a through hole, which communicates with the inner and outer spaces of the shell. The plug is set in the through hole of the hollow body.

With the above structure, the hollow paper hanging ornament of the present invention can be made of environmentally friendly materials, which can also achieve the purpose of festival decoration but can reduce the use of plastics and reduce environmental pollution and damage.

Preferably, the hollow body is flush with the outer surface of the shell at the through hole.

### BRIEF DESCRIPTION OF THE DRAWINGS

FIG. 1 is a schematic diagram of the appearance of the product used in the past.

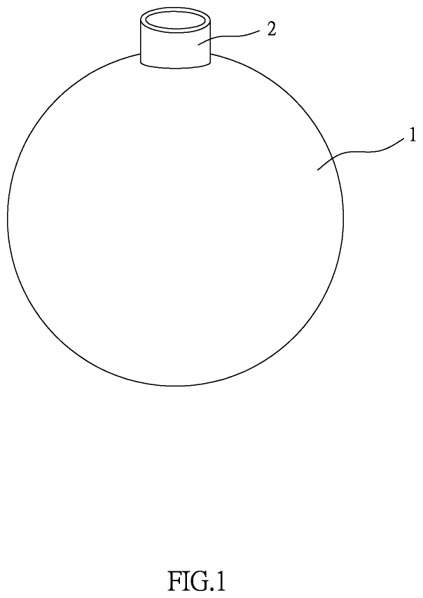

FIG. 2 is an exploded schematic view of the first embodiment of the present invention.

FIG. 3 is an exploded schematic view of the second embodiment of the present invention.

FIG. 4 is an exploded schematic view of the third embodiment of the present invention.

FIG. 5 is an exploded schematic view of the fourth embodiment of the present invention.

FIG. 6 is an exploded schematic view of the fifth embodiment of the present invention.

FIG. 7 is an exploded schematic view of the sixth embodiment of the present invention.

FIG. 8 is an exploded schematic view of the seventh embodiment of the present invention.

FIG. 9 is an exploded schematic view of the eighth embodiment of the present invention

### DETAILED DESCRIPTION OF INVENTION

The applicant first explains that in the entire specification, including the embodiments described below and the claims of the scope of the patent application, the terms related to the directionality are based on the directions in the drawings. Next, in the embodiments and drawings to be introduced below; the same element numbers represent the same or similar elements or their structural features. The directions indicated in the specification are the directions of the drawings for the convenience of description and are not limited thereto.

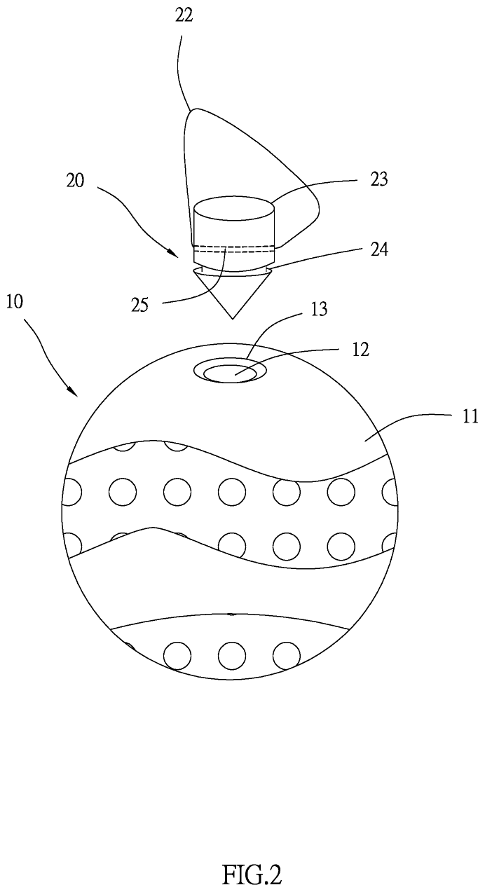

Referring to FIG. 2, the first embodiment of the present invention, the hollow paper hanging ornament of the present invention comprises a hollow body 10, a plug 20, and a hanging member 22.

The hollow body 10 is made of paper, and the paper referred to in this case can be paper or pulp, and in this embodiment, pulp is used as an illustrative example. The hollow body 10 comprises a shell 11 and an inner space 12 within the shell. One side of the shell 11 is provided with a through hole 13, which communicates with the inner and outer spaces of the shell 11. The hollow body is not provided with a protruding neck at the through hole 13 as in previous products, but is flush with the outer surface of the shell 11. In this embodiment, the through hole 13 is a circular through hole, but it is not limited to this. The through hole can also be square or triangular or other shapes. The outer surface of the shell 11 can be painted or printed or sprayed with various patterns, colors, etc. to decorate the shell.

The plug 20 is set at the through hole of the hollow body. In this embodiment, the plug 20 has a plunger 23, and the plunger has a concave annular groove 24. The outer diameter of the plunger 23 is larger than the hole diameter of the through hole 13, but the outer diameter of the annular groove 24 is smaller than the hole diameter of the through hole 13. Thereby, the plug 20 can be inserted into the through hole 13 of the hollow body with the plunger 23, and the shell 11 can be clamped in the annular groove 24. The plunger 23 is provided with a perforation 25.

The hanging member 22, which can be a rope loop or a hook, is worn on the perforation 25 and set on one side of the plunger 23. When the plug 20 is inserted into the through hole 13, the hanging member 22 is exposed outside the hollow body 10. After the plug 20 is combined with the hollow body 10, the hollow paper hanging ornament can be hung by the hanging member 22.

The advantages of the present invention that are different from those used in the past are:

Among the products used in the past, glass products are not easy to manufacture and process, and plastic products have environmental problems. The hollow body of the present invention is made of paper, has low manufacturing cost and can be completely recycled and reused without causing environmental pollution and damage. Furthermore, as explained in the background section above, most of these traditional hanging ornaments are made of glass blowing, so a protruding neck is left at the opening of the finished product, which is required for blowing. Therefore, one side of the sphere will protrude a section, and it looks a bit more in appearance. Later, due to the popularity of plastic products, many of these products are now made of plastic, but still retain the shape of the original glass products, leaving a protruding neck. However, this neck structure makes it difficult to form the molds related to the liquid pulp, which will reduce the yield of the pulp process and make it impossible for mass production. Therefore, there is no neck structure design in this embodiment.

In addition, the hollow body of the present invention is made of paper, so it is not easily damaged, and is easy to package and transport. And no matter the pattern or color on the surface can be easily changed, the processability and variability are extremely high, and the customizable elasticity is also extremely high. It can even provide a blank hollow body for customers to DIY, and draw their ow desired or unique patterns to increase the uniqueness and festive atmosphere of the product.

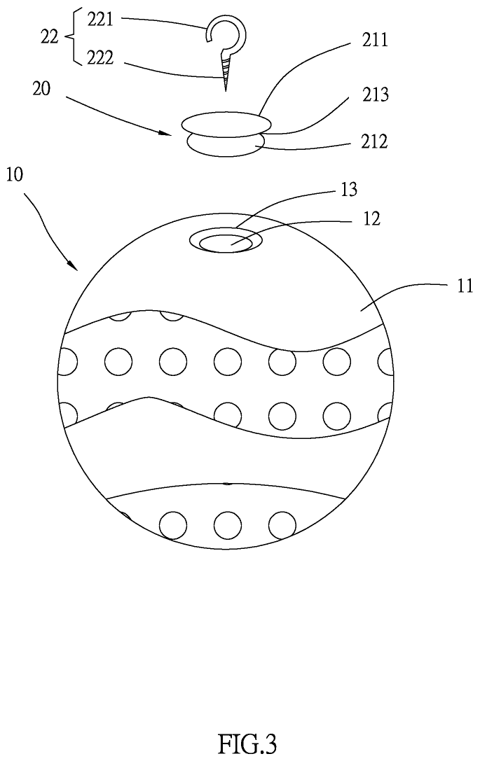

As shown in FIG. 3, it is the second embodiment of the present invention, and the hollow paper hanging ornament of the present invention comprises a hollow body 10 and a plug 20.

The hollow body 10 is made of pulp. The hollow body 10 comprises a shell 11 and an inner space 12 within the shell. One side of the shell 11 is provided with a through hole 13, which communicates with the inner and outer spaces of the shell 11. The hollow body is not provided with a protruding neck at the through hole 13, but is flush with the outer surface of the shell 11.

The plug 20 is set at the through hole of the hollow body. In this embodiment, the plug 20 comprises an upper wall portion 211, a lower wall portion 212, and a waist portion 213 with a smaller outer diameter formed between the upper wall portion 211 and the lower wall portion 212. The outer diameter of the waist portion 213 is smaller than the diameter of the through hole 13 while the outer diameters of the upper wall portion 211 and the lower wall portion 212 are larger than the diameter of the through hole 13. The plug 20 is mounted with a hanging member 22. The hanging member 22 has a ring portion 221 and a bolt portion 222, and the hanging member 22 is locked to the upper wall portion 211 with the bolt portion 222.

Thereby, the plug 20 can be inserted into the through hole 13 of the hollow body, and the shell 11 can be clamped in the waist portion 213. When the plug 20 is installed in the through hole 13, the hanging member 22 is exposed outside the hollow body 10 to provide hanging. Of course, the hanging member 22 may not be set on the plug 20, and the plug 20 is only for decoration.

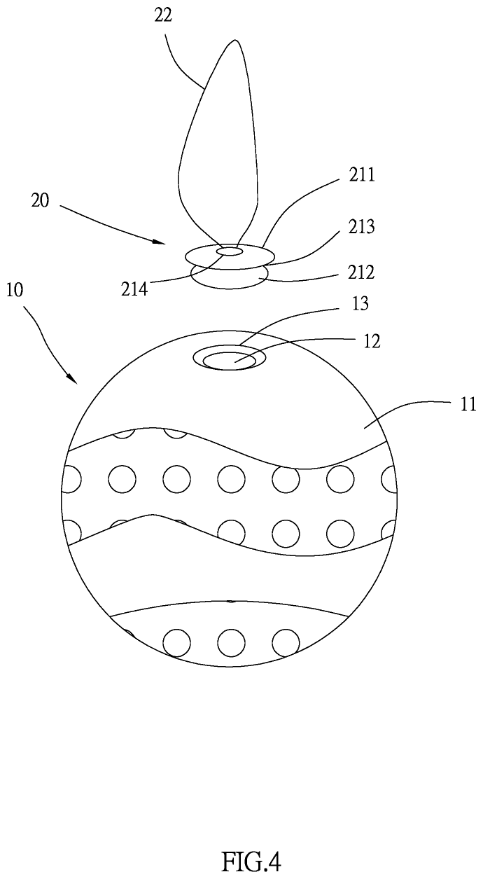

As shown in FIG. 4, it is the third embodiment of the present invention, and the hollow paper hanging ornament of the present invention comprises a hollow body 10, a plug 20, and a hanging member 22.

The hollow body 10 is made of paper. The hollow body 10 comprises a shell 11 and an inner space 12 within the shell. One side of the shell 11 is provided with a through hole 13, which communicates with the inner and outer spaces of the shell 11. The hollow body is not provided with a protruding neck at the through hole 13, but is flush with the outer surface of the shell 11.

The plug 20 is set at the through hole of the hollow body. In this embodiment, the plug 20 comprises an upper wall portion 211, a lower wall portion 212, and a waist portion 213 with a smaller outer diameter formed between the upper wall portion 211 and the lower wall portion 212. The outer diameter of the waist portion 213 is smaller than the diameter of the through hole 13. The plug 20 is also provided with a perforation 214, which runs through the upper wall portion 211 and the lower wall portion 212 from top to bottom.

The hanging member 22 is arranged on the plug 20, and the hanging member 22 is a rope loop, one end is passed through the perforation 214, and the other end is exposed on the plug 20.

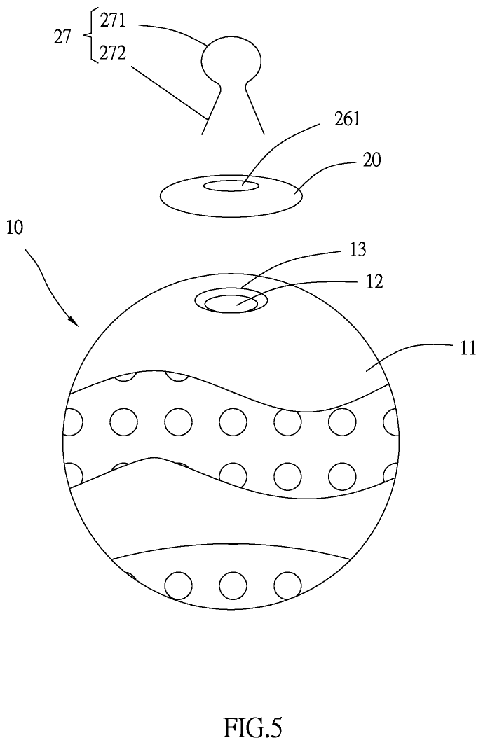

As shown in FIG. 5, it is the fourth embodiment of the present invention, and the hollow paper hanging ornament of the present invention comprises a hollow body a plug 20, and a hanging member 27.

The hollow body 10 is made of paper. The hollow body 10 comprises a shell 11 and an inner space 12 within the shell. One side of the shell. 11 is provided with a through hole 13, which communicates with the inner and outer spaces of the shell 11. The hollow body is not provided with a protruding neck at the through hole 13, but is flush with the outer surface of the shell 11.

The plug 20 is arranged at the through hole 13 of the hollow body. In this embodiment, the plug 20 is a decorative piece, the plug 20 is circular, and is covered at the through hole 13 of the hollow body, and the plug 20 has a hole 261.

The hanging member 27 comprises an annular portion 271 and two protruding arms 272. The annular portion 271 has a structure equivalent to a coil spring. The two arms 272 can be stretched by the elasticity of the annular portion 271, and can be compressed toward each other by external force. The two arms 272 can be compressed and passed through the hole 261 of the plug and the through hole 13 of the hollow body, and then stretched and stuck in the shell 11. Thereby, the hanging member 27 can hook the hollow body 10 and provide a hanging function.

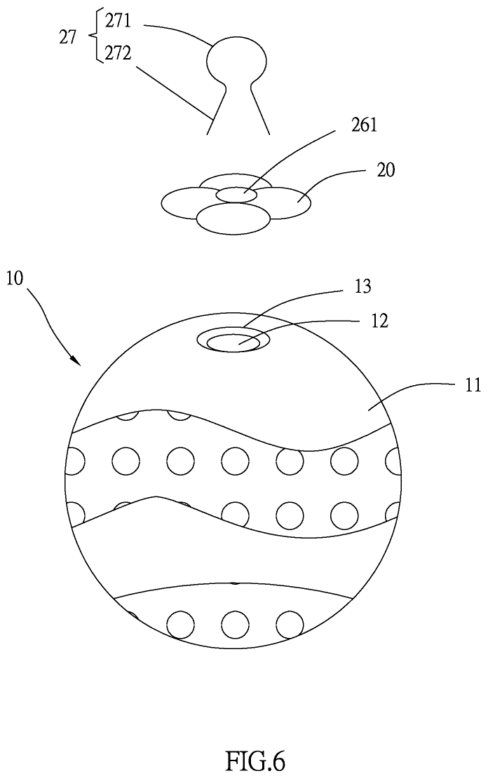

The plug 20 is not limited to a circular shape, and can also be made into other various forms to meet the needs of the shape. For example, it is a fifth embodiment of the present invention made of leaves or as shown in FIG. 6, its structure is the same as that of the fourth embodiment, but the plug is in the shape of a petal. The plug can be made of various environmentally friendly materials such as paper, metal, wood chips, etc.

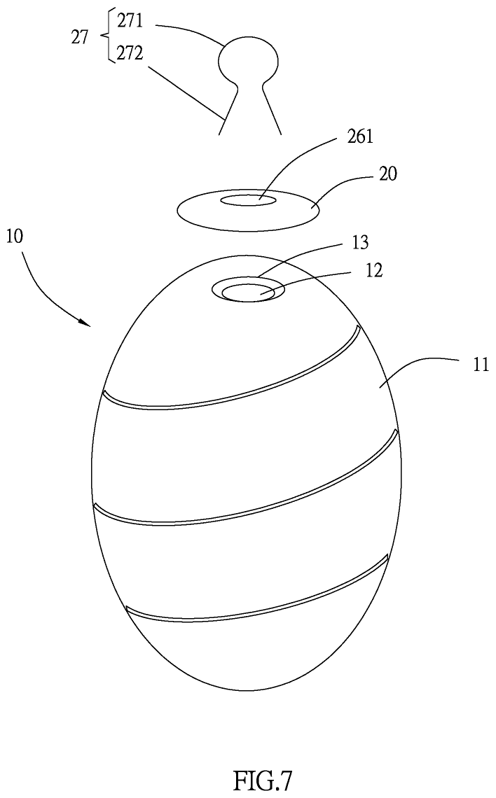

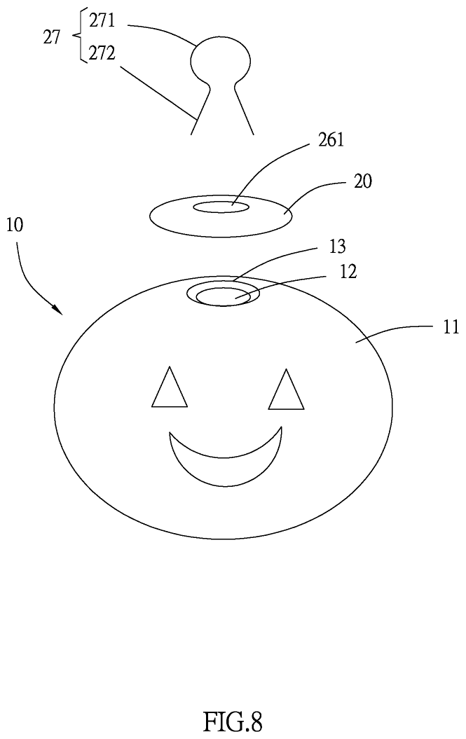

In the present invention, the hollow body is not limited to the spherical shape disclosed in the previous three embodiments. The hollow body 10 can also be made into different shapes according to different design requirements, such as: oval, heart, star, teardrop and other shapes. The sixth embodiment of the present invention is shown in FIG. 7. In this embodiment, the hollow body 10 is in the shape of an egg, with a spiral pattern on the outside. Or as shown in FIG. 8, which is the seventh embodiment of the present invention, the hollow body 10 is a horizontal ellipsoid, and a smiley face is drawn on the outside, which can greatly increase the variability and possible range of products without increasing manufacturing costs and causing environmental hazards.

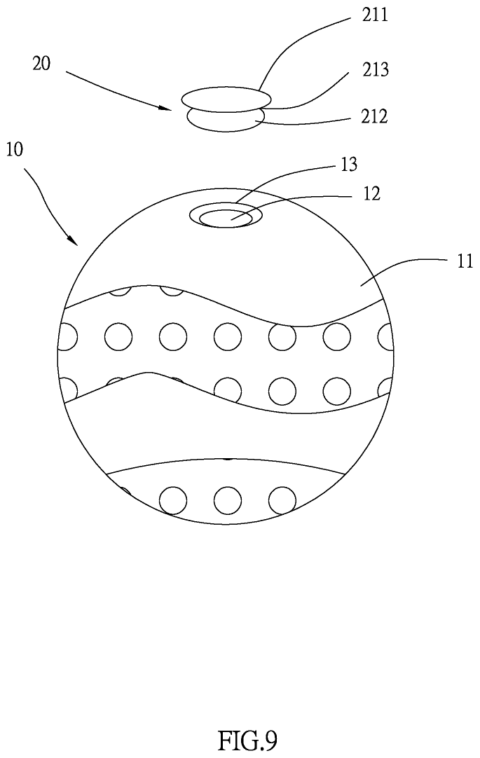

As shown in FIG. 9, it is the eighth embodiment of the present invention, and the hollow paper hanging ornament of the present invention comprises a hollow body and a plug 20.

The hollow body 10 is made of pulp. The hollow body 10 comprises a shell 11 and an inner space 12 within the shell. One side of the shell 11 is provided with a through hole 13, which communicates with the inner and outer spaces of the shell 11. The hollow body is not provided with a protruding neck at the through hole 13, but is flush with the outer surface of the shell 11.

The plug 20 is arranged at the through hole 13 of the hollow body. In this embodiment, the plug 20 comprises an upper wall portion 211, a lower wall portion 212, and a waist portion 213 with a smaller outer diameter formed between the upper wall portion 211 and the lower wall portion 212, The outer diameter of the waste portion 213 is smaller than the diameter of the through hole 13 while the outer diameters of the upper wall portion 211 and the lower wall portion 212 are larger than the diameter of the through hole 13,

What is claimed is:

1. A hollow paper hanging ornament, comprising:
a hollow body made of paper, said hollow body comprising a shell and an inner space within said shell, said shell being provided with a through hole, which communicates with the inner and outer spaces of said shell; and
a plug set at said through hole of said hollow body to cover said through hole.

2. The hollow paper hanging ornament as claimed in claim 1, wherein said plug comprises an upper wall portion, a lower wall portion, and a waist portion with a smaller outer diameter formed between said upper wall portion and said lower wall portion, the outer diameter of said waist portion being smaller than the diameter of said through hole.

3. The hollow paper hanging ornament as claimed in claim 2, wherein said plug is mounted with a hanging member, said hanging member comprising a ring portion and a bolt portion, said hanging member being locked to said upper wall portion with said bolt portion.

4. The hollow paper hanging ornament as claimed in claim 1, wherein said plug comprises an upper wall portion, a lower wall portion, and a waist portion with a smaller outer diameter formed between said upper wall portion and said lower wall portion, the outer diameter of said waist portion being smaller than the diameter of said through hole, said plug being provided with a perforation that runs through said upper wall portion and said lower wall portion from top to bottom, said plug being mounted with a hanging member, said hanging member being a rope loop pierced through said perforation and an opposite end thereof exposed.

5. The hollow paper hanging ornament as claimed in claim 1, wherein said through hole of said hollow body is flush with the outer surface of said shell.
